(19) United States
(12) Patent Application Publication
(10) Pub. No.: US 2005/0089815 A1
(43) Pub. Date: Apr. 28, 2005

(54) Dental device for modeling system with articulator, adjustable articulator stand, classified label and protective cover

(76) Inventor: Wan Ki Lee, Cupertino, CA (US)

Correspondence Address: JACOBSON HOLMAN PLLC, 400 SEVENTH STREET N.W., SUITE 600, WASHINGTON, DC, 20004, US

(21) Appl. No.: 10/691,703

(22) Filed: Oct. 24, 2003

(51) Int. Cl. A61C 11/00

(52) U.S. Cl. 433/60; 433/57; 433/213

(57) ABSTRACT

A three-dimensional articulator model having upper and lower base members movable in relation to each other through the action of a hinged articulator joint mechanism, and also having a built-in work stand and label assembly that is adjustable with the articulator mechanism. Each of the arch-shaped base members has a plurality of channels extending therethrough to receive a corresponding dowel pin tray having plurality of outwardly extending dowel pins with grooved end surfaces to facilitate insertion and removal of the pins from the base members. Dental casts are formed upon the dowel pin trays and the movement of the articulator provides for full jaw movement simulation through the design of the articulator joint mechanism. The workstand and label assembly provides a convenient and organized means for working on the model as well as for tracking the information associated with the particular model upon completion thereof, and the model is easily and safely transported in a specially designed carrying cover that protects the model while also providing identifying information in conjunction with the classification panel of the label assembly.

### BACKGROUND OF THE INVENTION

1. Field of the Invention

The present invention is related to the field of dental models and, more particularly, to a device for mounting tooth replications made from dental impressions. This provides for a dental model of the full jaw movement simulation of a patient's mouth using a pre-divided dowel pin tray modeling system with articulator assembly.

2. Description of the Related Art

There are currently several methods and designs for molding models simulating the full jaw movement of a patient's mouth, one of which is to individually drill holes from the bottom of the model and use adhesive to place the dowel pin in the hole. It is then necessary to use vibration to pour the plaster into a base mold, after which dowel pins must be set in place. This approach has several problems. It is difficult to drill the dowel pin holes accurately, and wax or dust tend to clog the dowel pin holes so as to prevent accurate positioning of the sectioned model part. Also, any particles which may be accidentally lodged in the dowel pin holes are very difficult to remove. As a result, this known dowel method is time consuming, inaccurate and complicated.

According to another more recent approach, dental castings are made by embedding the stone in a casting cavity in which the poured gypsum stone is retained within a cast member. This newer approach uses armatures disposed on the cast member which cooperatively engage a parallel undercut or other mechanical loop of the stone member. The use of these armatures is limiting in that all of the dies must either be engaged or disengaged from the cast member. It is very hard to disengage the full teeth model without using a specialty hammer or other instrument to separate the model from the cast. Another problem resides in the fact that the wet stone becomes enlarged during the setting process which makes it nearly impossible, once the model is removed from the cast, to regain the right fit.

Another problem with the existing die cast system is that, when the die is placed in the oral cavity, it cannot be ascertained whether the entire mold cavity has been filled with the wet stone material. Instead, spaces may occur in the cavity where improper filling has occurred that lead to weakening and imperfections in the model.

To provide a truly effective dental model, the dental casts need to represent the relationship between the patient's upper and lower teeth. Accordingly, dental casts of the patient's upper and lower sets of teeth are connected by a dental articulator that is able to simulate the actual movement of the patient's jaw. The motion simulated by the articulator needs to accommodate for vertical, lateral and protrusive jaw movements.

Previous articulators were bulky, being made of metal with the dental model attached using plaster. More currently, articulators in use are made of plastic, with dental models being attached using super glue, making them easier to work with and providing for a more accurately finished product. However, the glue is toxic and messy. Furthermore, this process is time-consuming and costly, and requires an experienced technician to perform the task accurately.

Recently, dental model articulators have been designed to have detachable articulator systems from cast to provide an efficient means of working on the dental model. However, these articulators do not always provide full jaw movement simulation capability, sometimes relying on semi-flexible plastic to provide protrusive movement which can lead to accidental breaking of the model or distortion of the model placement in comparison with the articulator.

Another difficulty with prior art dental modeling devices is that they do not allow for ease of use. More particularly, when working on such models, every technician has a different height, habits, tools and method, and he or she is often forced to employ a variety of crude items at the working table in order to stand the dental model in an upright position. Therefore, a need exists for an adjustable work stand that is fixed to the articulator and which allows the technician to work efficiently and accurately.

When working with dental modeling devices, it is typical to have several in development and it can be difficult to keep track of the particular features of each. In the case of special prescription orders, the data sheets can be misplaced, as can key information relating to the particular patient's name, shade record, median line, sectional diagram, pan number and work number. An easier means of properly labeling and organizing dental models is therefore needed. In addition, once the model is complete, a secure means of storing and transporting is very important to prevent loss of parts as well as chipping or scratching of the stonework.

### SUMMARY OF THE INVENTION

In view of the foregoing, one object of the present invention is to overcome the difficulties in molding dental models with an improved method and apparatus that provides dental technicians with a simple and convenient procedure that minimizes the time and skill necessary to complete the task without error.

Another object of the present invention is to provide a method and apparatus for the simple and easy creation of conveniently removable and resettable dies, without the need for any additional instruments.

A further object of the present invention is to provide detachable dies having at least two dowels per tooth which can be paired effortlessly with corresponding hollow channels in a base model, allowing for an accurate and precise convergence and preventing the improper reseating of dies.

Yet another object of the present invention is to provide an arch-shaped base model including numerous evenly spaced, parallel hollow channels extending therethrough, the open ends of each channel preventing the collection of dust therein such that improper seating of the dies is avoided and cleaning is simplified.

A still further object of the present invention is to provide a base model with channels extending therethrough, channels in the posterior ends of the base model being oval-shaped prisms for improved durability and channels at the anterior end being triangular prisms to improve the stability of the smaller dies.

Yet a further object of the present invention is to provide a corresponding dowel pin tray for use with a base model, the tray having a plurality of projecting dowel pins shaped to match the prism shape of the dowels so that, when inserted in the base member, the dies are held securely in place.

Another object of the present invention is to provide dowel pins with beveled surfaces forming a W-shaped valley for easier insertion of dies, the beveled surfaces also extending beyond the bottom surface of the base model for improved ease in removing the dies.

Yet another object of the present invention is to provide a base model having legs to provide sufficient clearance for dowel pin extension through the bottom surface thereof.

A still further object of the present invention is to provide a dowel pin tray having arch-shaped vertical extensions arising from the platform of the tray from which horizontal bars extend to securely retain the dental stone used to make the mold.

An additional object of the present invention is to provide an improved articulator having an horizontal space at the junction thereof that allows for protrusive and side-to-side movement to more accurately replicate a functioning jaw, and further having a retractable spring guider on the arms that connect the two bases that automatically retreats to the original model position.

A further object of the present invention is to provide an articulator that keeps the two bases steady at the correct level and occlusion of the upper and lower jaws, preventing unequal distribution.

Yet a further object of the present invention is to provide an articulator with an adjustable work stand that allows a dental technician to work with the model at a chosen and consistent angle.

A still further object of the present invention is to provide an integrated labeling system for improved convenience and accuracy in organizing dental models.

Another object of the present invention is to provide a simple and highly protective packaging cover to prevent damage to the casting.

In accordance with these and other objects, the present invention is directed to a three-dimensional articulator model having upper and lower base members movable in relation to each other through the action of the hinged articulator joint mechanism, and a built-in work stand and label assembly that is adjustable with the articulator mechanism. Each of the arch-shaped base members has a plurality of channels extending therethrough such that a dowel pin tray having a plurality of outwardly extending dowel pins may be snugly fitted into each of the upper and lower base members, the dowel pins having a grooved end surface to facilitate removal of the pins from the base members. Dental casts are formed upon the dowel pin trays and the movement of the articulator provides for full jaw movement simulation. The workstand and label assembly provides a convenient and organized means for working on the model as well as for tracking the information associated with the particular model upon completion thereof. The completed model is easily and safely transported in a specially designed carrying cover that protects the model while also providing identifying information in conjunction with the classification panel of the label assembly.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a perspective view of a three-dimensional articulator model with an attached upper and lower dowel pin tray on each of the upper and lower base members, according to the present invention;

FIG. 2 is a perspective view of the three-dimensional articulator model of FIG. 1, with transparency of the elements to show the dowel pin holes with corresponding fitted dowel pins;

FIG. 3 is a bottom view of the model as viewed along line 3-3 of FIG. 2;

FIG. 4 is a side view of the articulator model with adjustable work stand and labeling system as viewed along line 4-4 of FIG. 2, the upper base member fitted with a corresponding dowel pin tray to which a dental cast has been embedded, according to the present invention;

FIG. 5 is a side view of the assembled articulator arm at rest point in accordance with the present invention, as viewed along line 5-5 of FIG. 2;

FIG. 6 is an exploded perspective view of the articulator with the lower base member attached and a dowel pin tray in alignment therewith, the dowel pin channels in the lower base member being hidden and the median line shown;

FIG. 7 is a top view of the articulator arm as viewed along line 7-7 of FIG. 6;

FIG. 8 is a side view of the articulator, as viewed along line 8-8 of FIG. 6;

FIG. 9 is another side view of the articulator with partial cut-away, as viewed along line 9-9 of FIG. 6;

FIG. 10 is a perspective view of the male head of the articulator, as viewed along line 10-10 of FIG. 6;

FIG. 11 is a perspective view of the female head of the articulator, as viewed along line 11-11 of FIG. 6;

FIG. 12 is another perspective view of the three-dimensional articulator model according to the present invention, with transparency of the elements to show the dowel pin holes with corresponding fitted dowel pins in the lower base member, the upper base member shown in the swung open position and without a dowel pin tray;

FIG. 13 is a rear view of the lower base member with the dowel pin tray inserted as viewed along line 13-13 of FIG. 12;

FIG. 14 is a perpendicular top view of the upper base member with label as viewed along line 14-14 of FIG. 12;

FIG. 15 is a protective cover into which the articulator model may be inserted, in accordance with the present invention;

FIG. 16 is another exploded perspective view of the articulator with the lower base member attached and a dowel pin tray in alignment therewith;

FIG. 17 is a top view of the dowel pin tray as viewed along line 17-17 of FIG. 16;

FIG. 18 is a side view of the exploded articulator with lower base member and dowel pin tray as viewed along line 18-18 of FIG. 16;

FIG. 19 is a frontal view of the exploded articulator with lower base member and dowel pin tray as viewed along line 19-19 of FIG. 16;

FIG. 20 is an enlarged perspective view of a portion of the lower base member with adjustable work stand as viewed along line 20-20 of FIG. 16;

FIG. 21 is a cross-sectional view along line 21-21 of FIG. 20;

FIG. 22 is a rear view of the dowel pin tray as viewed along line 22-22 of FIG. 6;

FIG. 23 is a side view of the dowel pin tray as viewed along line 23-23 of FIG. 6;

FIG. 24 is a side view of a dowel pin tray into which dental casts have been embedded, each tooth being individually removable and having at least two dowel pins for secure mounting in the base members.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

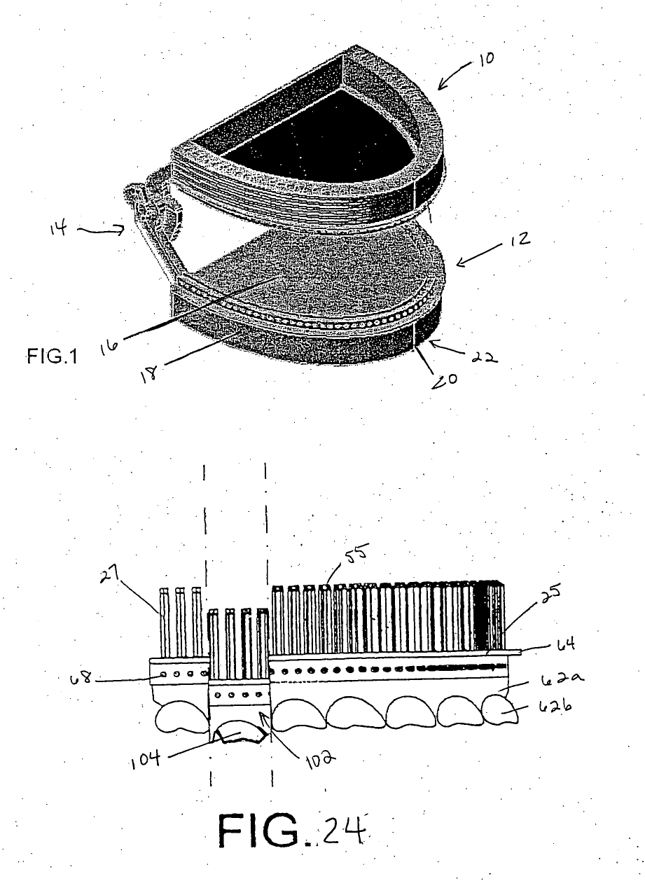

A complete dental model according to the present invention is illustrated in FIG. 1. The model includes an upper base member 10, a lower base member 12 and an articulator 14 for coupling the base members while enabling vertical, lateral and protrusive movements of the base members relative to one another simulating actual jaw motion. A workstand and label panel assembly 16 is conjoined with the lower base member 12, to provide for the individual preferences of each technician. There are also side surface labels 18, which are preferably formed by etching into the plastic, onto which technicians can write further comments. Alternatively, a pre-printed paper adhesive label can be applied to the side surface, whether or not the side surface is etched. A median line 20 is also provided on the side surface, representing the central position of the human jaw's location point to provide for correct placement of the mold. Teeth patterns 22 protrude from the side surface around the central position line, onto which technicians can write the appropriate color of the particular patient's teeth.

The model supports an upper and lower dental cast which, when fitted on the upper and lower base members 10, 12, enables a dental care professional to accurately observe the fit and interaction between the patient's upper and lower teeth, with realistic jaw motion being simulated by the articulator 14. The upper and lower base members are preferably made of a durable plastic material, providing for the safety of the dies and the resulting dental model.

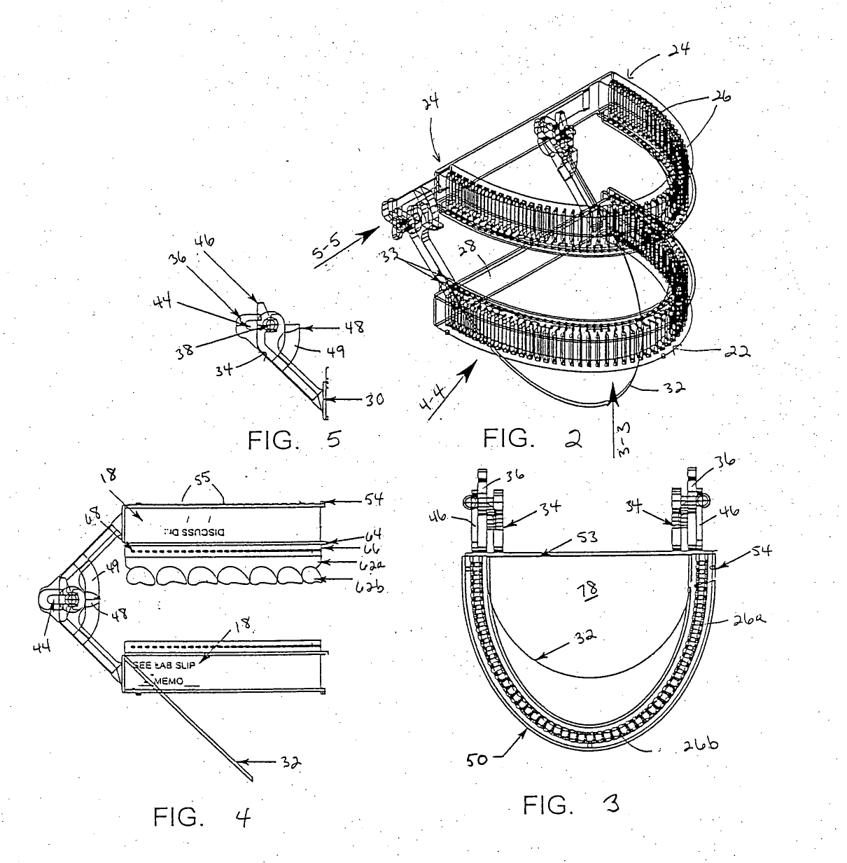

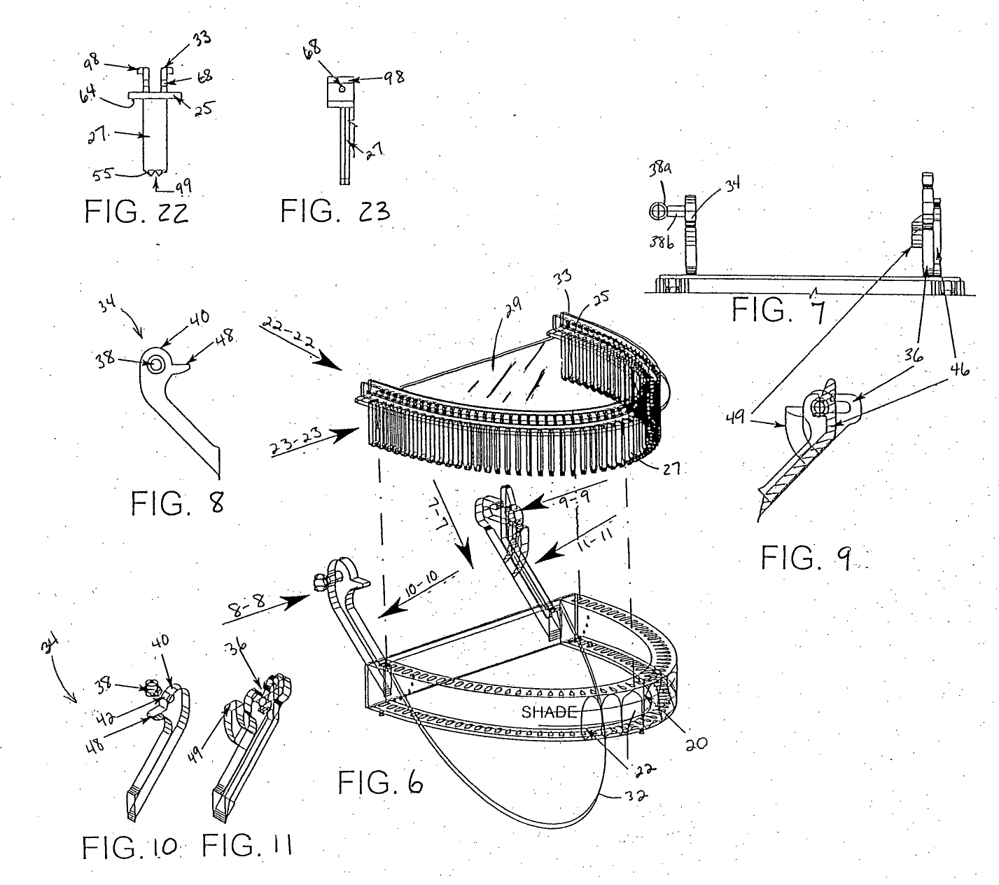

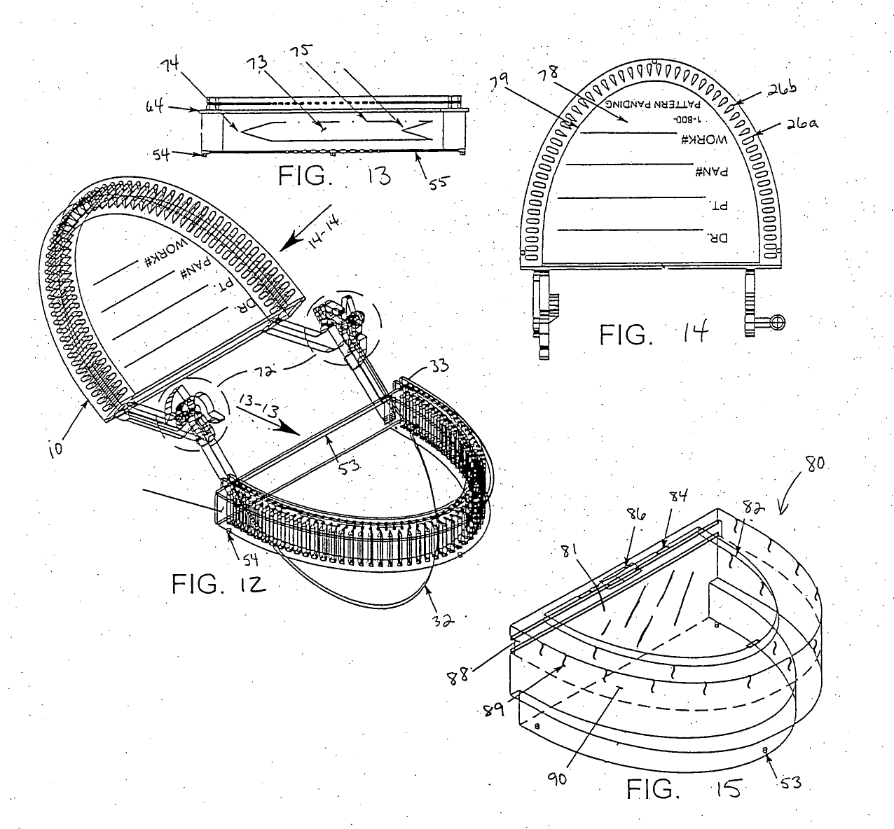

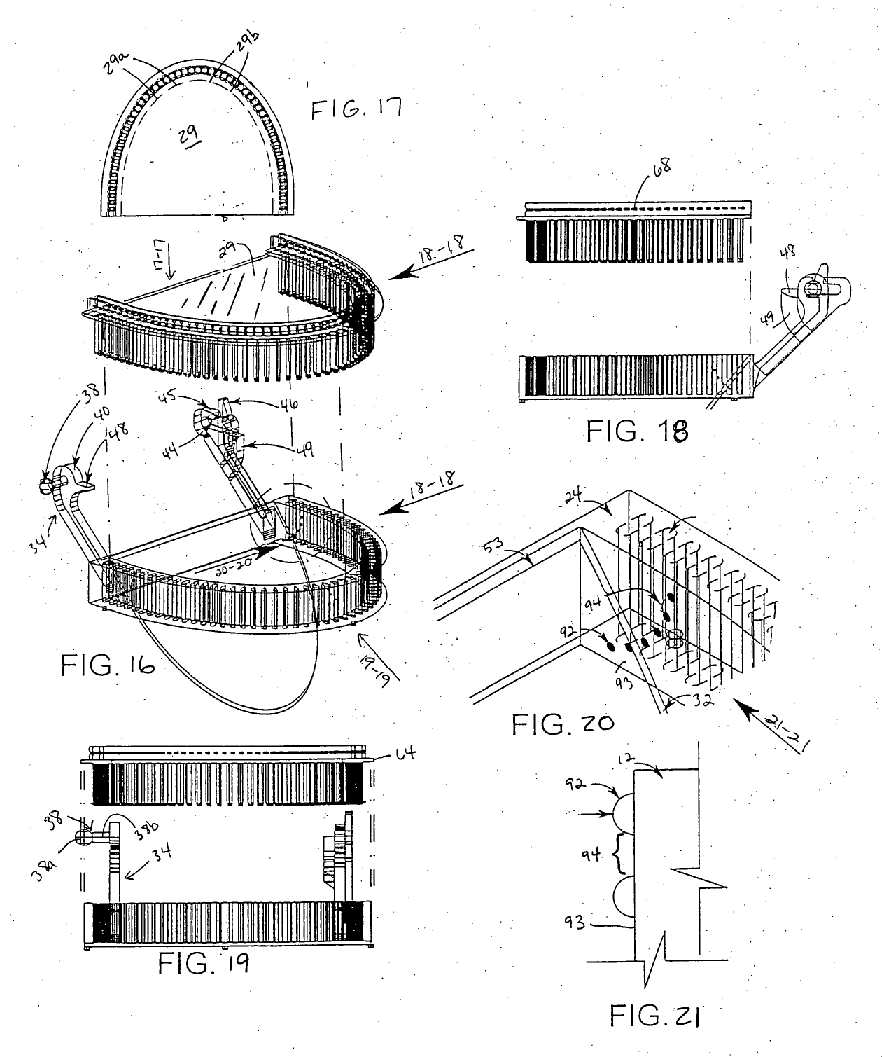

As shown in greater detail in FIG. 2, each of the upper and lower base members 10, 12 has an arch-shaped span extending between two posterior ends 24 and approximating the generally semi-circular arrangement of human teeth. The base members include a plurality of evenly spaced, generally parallel hollow channels 26 which pass from top to bottom through each base member, the adjacent channels having a number sufficient to extend from each posterior end 24 along the length of the arch-shaped span. Because the channels are open at both the top and bottom, dust collection within the channels is prevented, cleaning facilitated, and proper seating of the dies ensured. The posterior ends 24 are joined by a base wall 28. Also coupled to the articulator and cooperatively fitted with the lower base member 12 and the base wall 28 is the adjustable workstand and label panel assembly 16 which includes a workstand 32 and an associated classification panel 78. In addition, there are two or more arch-shaped vertical extensions 33 alongside each other to take into consideration varying jaw sizes. This provides for a one-size-fits-all type of dental modeling system, ensuring versatility and complete stability.

FIG. 3 is a bottom view as seen along line 3-3 of FIG. 2. As may be seen, the channels 26 have different shapes, including oval-shaped prisms 26a in the posterior ends 24 for improved durability and triangular prisms 26b at the anterior end 22 to improve the stability of the smaller dies. The outer edge 50 of the lower base model has an extended width to accommodate grinding. The bottom surface of the lower base model 12 is also provided with legs 54 which create sufficient clearance for the protruding ends 55 of the dowel pins when a dowel pin tray is inserted. The workstand 32 moves about a hinge 53 provided on the base wall 28, and the classification panel 78 formed therewith can be torn off when the model is complete and attached as a work record to a packaging device, preferably the safety carrying container shown in FIG. 15 and described hereinafter.

Each of the upper and lower base models is designed to receive a dowel pin tray 60 having a complementary arch-shaped platform 25 and a plurality of outwardly extending dowel pins 27 for insertion into the plurality of channels 26. The dowel pins are in the shape of prisms and are sized to match the respective channels 26a, 26b. The arch-shaped platform 25 has a width greater than that of the dowel pins to form a flange 64 on either side thereof to accommodate a range of different mouth sizes. Dental casts are molded onto the dowel pin trays and can thereby be mounted to the articulator model for jaw manipulation simulation. Slight divots may also be formed along the platform 25 between the arch-shaped vertical extensions 33 to increase the security of dental stone retention.

On the outer sides of the base members 10, 12, etching of the surface provides for the outer side labels 18, shown in FIG. 4, which enable the dental technician to mark the model with necessary information which may include imprinted letters, logo, shade or memo data, as necessary to record and organize various jobs. With this labeling capability, the dentist can store the necessary information directly with the model and thereafter identify a particular model quickly and easily, making further notations thereon as necessary without the need to make additional impressions.

FIG. 4 also depicts the upper and lower base models, the upper base model with a dowel pin tray 60 having a dental cast 62 embedded therein, including gums 62a and teeth 62b of the same stone material. The flange 64 on the dowel pin tray 60 sticks out from the side wall of the base member. With this protrusive flange 64, when the gypsum material is poured onto the negative dental impression tray, it is easy to accomplish a smooth trimming of the embedded top along the vertical retention strip 66 and solidified mold. Retention holes 68 are used to hold the molds in place for purposes of stability, receiving corresponding projections 98 on the dies, as will be discussed hereinafter in connection with FIGS. 22 and 23, although others means of affixing the molds may also be used.

The outer surfaces of the base members 10, 12 are provided with legs 54 to allow clearance for the ends 55 of the dowels, seen projecting through the upper base member in FIG. 4, preventing contact of these ends 55 with the work surface and thereby providing stability to the model. This clearance is also necessary to prevent the dowel pins, or the dies to which they are connected, from being lifted out of the base member through contact with the work surface.

FIG. 5 is a side view of the assembled articulator 14 as viewed along line 5-5 of FIG. 2. The articulator includes first and second articulator arms 34, 36 which are snapped together to work cooperatively together as a single unit. To provide greater clarity, FIG. 6 illustrates the two types of articulator arms 34, 36 but depicted alone, each connecting to its complementary mate coupled to the upper base member, to form therewith a single movable unit. Specifically, the first articulator arm 34 of the lower base member works cooperatively with the second articulator arm 36 of the upper base member, while the second articulator arm 36 of the lower base member works cooperatively with first articulator arm 34 of the upper base member. Each articulator arm is coupled to the base wall 28 at an arm connecting surface 30.

Various views of the articulator arms are provided in FIGS. 7-11. With reference thereto, each pair of articulator arms 34, 36 works cooperatively with a Temporal Mandibular Joint (TMJ) pivotal spindle 38. The first articulator arm 34 includes a round head 40 having an opening 42 which receives the pivotal spindle 38. The rounded head 40 allows for smooth opening and closing of the articulator, while the spindle includes a ball-shaped head 38a attached to a narrower spindle portion 38b which fits cooperatively within the generally rectangular chamber 44, formed by the chamber support arm 45 of the second articulator arm 36, to allow for a full range of movement to replicate the jaw including protrusive movement. For example, if protrusive enforcement of the base member requires side-to-side or full arch movement, the spindle 38 can move protrusively on the hinge of spindle 38 or horizontally within the chamber 44.

The range of movement provided by the articulator 14 allows the upper and lower base members 10, 12 to be moved relative to one another in response to manual manipulation. The second articulator arm 36 is also provided with a spring guider or retractor 46 that moves the articulator arms back into their original “at rest” position when any manipulative pressure being applied to the articulator is released.

The first and second articulator arms 34, 36 include first and second occlusal stoppers 48, 49, respectively. These occlusal stoppers 48, 49 are used in conjunction with another by the dental technician, when working with occlusal balancing such as the grinding of gold crown, porcelain or denture teeth. The interaction of the first and second occlusal stoppers 48, 49, shown in FIG. 4 with the adjusted finished bite of occlusion, is very important for guiding, particularly in the case of extended bridge work or a lot of teeth missing. If a lot of teeth are missing, for example, the model, acting in response to the retractor 46, may revert back to the original position too quickly, such that the mounted teeth may be broken or the articulator arm bent out of the occlusal position, leading to inaccurate results. The occlusal support provided by the stoppers 48, 49 prevents this result, affording an improved mastication model. The stoppers also prevent unequal distribution of model levels due to too much pressure exerted on one side or too much grinding. In addition, with long bridge work, the level balanace between the upper and lower base members is uneven, a problem that is solved by the action of the occlusal stoppers 48, 49.

FIG. 6 also illustrates the lower base member 10 with an unattached dowel pin tray 60 shown above and in alignment therewith. A removable plastic plate 29, connected to the dowel pin tray, lends greater structural integrity to the tray while also preventing spillage resulting from the pouring of the dental mold onto the tray. The lower base member 10 is shown with the dowel pin channels hidden and the median line 20 visible. The teeth patterns 22 on the outer surface may be used by the technician to customize tooth shades and to record such shades on the protruding tooth pictures.

FIG. 12 depicts the articulator model in an open position, with the upper base member 10 illustrated without a dowel pin tray and the lower base member with an engaged dowel pin tray 60. The operation of the two articulator heads 14 as previously described is shown in the circled areas 72.

A back view of the rear wall 28 is provided in FIG. 13, viewed along the line 13-13 of FIG. 12. The fringe 64 of the base platform extends outwardly to help guide the shaving of the excess gypsum stone material, as noted earlier in connection with FIG. 4. This protrusive fringe also allows the model to be used with any size mouth.

A tool 73 is stamped into the rear wall 28 during manufacture, and may be pressed out along perforated holes 74 provided in the rear wall 28 to break the connecting areas 75. The tool is connected to the rear wall 28 only by these connecting areas 75, with the rest of the perimeter of the tool being unattached to the model. This tool 73 may be used to eject the dowel pins or to push the die down to obtain a snug fit. After use, this tool may be stored with the model in the containment case 80, shown in FIG. 15.

FIG. 14 depicts a top view as seen along line 14-14 of FIG. 12 of the upper base member 10, shown without a dowel pin tray and illustrating the cylindrical channels 26a and triangular channels 26b for dowel pin setting. The triangular channels 26b provide a means for accommodating crowded anterior positioning and for the cutting of each individual tooth around a large curb so as to avoid separating the dowel pin into two teeth. Mathematically, the dowel pins are positioned so that there are at least two dowel pins per tooth.

The classification panel 78 formed with the workstand 32 can be used later for a work record. Because it is formed by etching, the label can be marked using any writing medium, including among others a pencil, ballpoint or felt pen, marker, etc. The label includes all pertinent information including the doctor's name, patient's name, working pan number, shade logo, sectional diagram, median line, etc. In this way, there is no need to refer back to the laboratory slip to review the information, except in the case of special prescriptions. After the model work is done, the panel 78 is torn off along the line 79 and may thereafter be inserted into a label holding seat 82 in the container 80, shown in FIG. 15, for easy categorizing.

The container 80 provides a storage area for the articulator model, having an opening 81 through which the model is inserted. Recessed areas 53 correspond with legs 54 on the base member so that, when the model is properly inserted, the legs “snap” into the recesses for secure retention.

To properly identify the model that is in the container, the label is placed in the label holding seat 82 where it is further supported by the lip 84. An indentation 86 is provided to allow for easy finger access to remove the label. A tool storage area 88 for the tool 73 is provided on an outer area of the container. After the model is packaged and delivered to the dental office, the dentist can first remove the tool 73 and then use the tool to lever open the cover slip and slide the articulator out the opening 81 to remove it from the case.

When loading the model into the container 80, a flexible cardboard holder, soft bristle structure 89 or sponge 90 is included to hold the completed teeth or die or any part of the model section, depending upon the nature of the model that is inserted within the container, snugly against the bottom of the container to prevent the model from coming loose during delivery. Like the base members, the container may be reused to save money and to take environmental considerations into account.

FIG. 16 is another illustration of the lower base member 10 with an unattached dowel pin tray 60 shown above and in alignment therewith. The dowel pin tray 60 may be mounted thereon by inserting the dowel pins into the corresponding channels. When fully inserted, the ends 55 of the dowel pins will extend beyond the bottom surface of the lower base member, as shown in the upper base member of FIG. 4. A top view of the dowel pin tray 60 as viewed along line 17-17 of FIG. 16 is shown in FIG. 17.

FIG. 17 illustrates the removable plate 29, which acts as a protective cover for label plate 78 of FIG. 14, and is used when technicians pour the mold onto the dowel pin tray. Long perforated holes 29a along with small connecting areas 29b provide for easy removal of the protective plate from the dowel pin tray platform. Side and front views of the dowel pin tray and the lower base member as seen along line 18-18 and line 19-19, respectively, are provided in FIGS. 18 and 19.

FIG. 20 is an enlarged view of the circled portion of the posterior end 24 of the lower base member 12 shown in FIG. 16, showing in greater detail the oval-shaped prisms of channels 26a and, in conjunction with FIG. 21, the adjustable work stand holder for the work stand 32. The work stand holder includes a plurality of dome-shaped protrusions 92 arranged in a semi-circular pattern on an inner wall 93 of the lower base model 12. The work stand 32, which fits snugly by contact against the inner wall 93, can be pushed up or down, turning on hinge 53, to cross over one or more dome-shaped protrusions 92 and thereafter rest in one of the grooves 94 formed by two adjacent domes 92. In response to manipulation by a dental professional or other user, the edge of the work stand 32 simply slides over the domes 92 until a desired position is reached, at which point the stand is held within the respective channel 94 by the adjacent domes 92 for secure and efficient positioning thereafter. This “click in place” technique allows a desired angle of the articulator position to be quickly and repeatably obtained for fast, accurate and convenient model fabrication.

An enlarged view of a dowel pin 27, of the type extending from the platform 25 of the dowel pin tray as seen from views 22-22 and 23-23 of FIG. 6, is shown in FIGS. 22 and 23, respectively. The vertical extensions 33 arise from the platform 25 and include a plurality of retention holes 68 passing therethrough, with the top of each vertical extension 33 being further provided with one or more horizontally extending projections or eaves 98. The eaves 98 and the retention holes 68 provide for a stable and firmly affixed dental stone, virtually eliminating any likelihood that the dental cast will fall off the dowel pin tray once hardened thereon.

The end 55 of each dowel pin has a beveled surface 99, forming an essentially w-shaped valley that provides for easy insertion of the pins into their corresponding hollow channels in the base member. The w-shaped valley surface 99 also facilitates easy removal of the dies by providing a secure surface against which to press the tool 73 or a fingernail, pencil or other device with a pointed or edged tip. The snug fit between the channels 26 and the correspondingly shaped dowel pins 27 prevents the dies from becoming inadvertently disengaged from the base members in the absence of pressure being applied to the dowel pin ends 55.

The dowel pin tray system is modeled for the purpose of allowing for each tooth to be embedded with a plurality of dowel pins, as representatively shown in FIG. 24. After the dowel pin tray and base members are converged together, the dental stone is mounted on the platform of the tray. Once the stone is set, the dowel pin tray is removed from the base and cut into sections or dies 102, each die having respective dowel pins embedded therein. At a minimum, two dowel pins should be embedded in each tooth to provide for the stability of the individual tooth, providing no sway and rotation of the dies and thereby obtaining an accurate result. The die 102 is shown with the dentist's tooth foundation 104 for supporting a crown or other final tooth construction.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A dental modeling device comprising:
an upper base member having an arch-shaped span with a plurality of substantially parallel channels passing therethrough, and a rear wall joining posterior portions of said span;
a lower base member having an arch-shaped span with a plurality of substantially parallel channels passing therethrough, and a rear wall joining posterior portions of said span;
an articulator coupled to and joining said upper and lower base members along said rear walls to form a dental model, said articulator providing hinging and pivotal motion of said base members about an axis;
an adjustable workstand and label panel assembly coupled to at least one of said upper and lower base members, said workstand providing adjustable positioning of said dental model on a work surface and said label panel containing textual information and being physically associated with said model; and
a protective case adapted to receive the dental model and display said label for storage and transport of said model.

2. The device as set forth in claim 1, wherein each of said upper and lower base members is coupled to a respective arch-shaped dowel pin tray, each dowel pin tray having a platform with a plurality of dowel pins extending therefrom which fit into corresponding ones of said plurality of channels.

3. The device as set forth in claim 2, wherein each of said plurality of channels includes generally triangularly-shaped channels in an anterior portion of said base members and generally oval-shaped channels in said posterior portions of said base members, said plurality of dowel pins on each dowel pin tray being complementarily shaped to fit into said channels such that dowel pins in an anterior portion of said tray are generally triangularly-shaped prisms and dowel pins in posterior portions of said tray are generally oval-shaped prisms.

4. The device as set forth in claim 2, wherein said arch-shaped dowel pin tray includes a fringe that is wider than said corresponding base member to allow for easy trimming of excess dental stone when forming a dental cast upon said tray.

5. The device as set forth in claim 2, wherein said arch-shaped dowel pin tray includes at least two vertical extensions extending from said platform opposite said dowel pins to accommodate varying dental cast sizes.

6. The device as set forth in claim 3, wherein said workstand is hingedly connected to the rear wall of said lower base member, said label panel extending outwardly from said hinge toward the anterior portion of said respective base member.

7. The device as set forth in claim 6, wherein an inner surface of at least one of said posterior portions includes a plurality of dome-shaped protrusions in a semicircular arrangement, adjacent protrusions forming grooves therebetween, said workstand having an edge that fits snugly against said inner surface and is adjustable to fit within one of said grooves to change an orientation of said model on the work surface.

8. The device as set forth in claim 6, wherein said label panel is detachable from said workstand, said protective case having a corresponding label holding seat for securing said detached label panel therein.

9. The device as set forth in claim 8, wherein said case further includes a finger groove adjacent said label holding seat to allow for easy removal of said label from said seat.

10. The device as set forth in claim 1, wherein at least one of said base members has an etched area on a side surface thereof for writing on said side surface.

11. The device as set forth in claim 2, wherein free ends of said dowel pins protrude from said base members when fully inserted therein, said free ends having a w-shaped end surface to facilitate insertion and removal of the dowel pins from said base members.

12. The device as set forth in claim 11, wherein at least one of said rear walls includes a removable tool punch-marked therein, said tool having a pointed tip to press cooperatively against said w-shaped surface to remove the dowel pins from said base member.

13. The device as set forth in claim 1, wherein said protective case includes a layer of compressible material on an inner surface thereof to cushion and snugly secure the model within the case.

14. The device as set forth in claim 1, wherein said lower base member includes at least two protrusions on an outer surface thereof, said protective case including corresponding apertures on an inner surface thereof such that, when said model is inserted into the case, the protrusions snap into said apertures to hold the model.

15. The device as set forth in claim 1, wherein said articulator includes first and second articulator arms, said first articulator arm having a rounded head with a through-passing hole, said second articulator arm having a chamber support arm that defines a generally rectangular channel, an elongated spindle element passing freely through said hole for hinged movement therein and also movable within said channel to provide for cooperative movement of said first and second arms to simulate side-to-side and protrusive jaw movement using said model.

16. The device as set forth in claim 15, wherein said second articulator arm includes a retractor for acting, in an absence of manual manipulation of said model, to automatically return the model to an at-rest position in which the upper and lower base members are substantially parallel with one another.

17. The device as set forth in claim 16, wherein each of said first and second articulator arms include a corresponding occlusal stopper that works complementarily with the occlusal stopper of the other arm to prevent collision between dental casts formed upon said dowel pin trays upon action of said retractor.

18. The device as set forth in claim 15, wherein each of said upper and lower base members is provided with a first articulator arm and a second articulator arm, the first articulator arm of said upper base member having a snap-in fit with the second articulator arm of said lower base member through insertion of the respective ball-shaped spindle into the corresponding channel, and the second articulator arm of said upper base member having a snap-in fit with the first articulator arm of said lower base member through insertion of the respective ball-shaped spindle into the corresponding channel, each coupled pair of articulator joints being connected to respective rear walls of said upper and lower base members proximal the posterior portion thereof.

19. The device as set forth in claim 2, wherein each of said dowel pin trays has a dental cast embedded therein such that, when stone forming the cast is set, the dowel pin tray is removed from the base member and cut into a plurality of dies, each die having at least two dowel pins embedded therein such that each die may be individually inserted and removed from said base member relative to other of said plurality of dies.

20. The device as set forth in claim 2, further comprising a protective plate connected along a line of perforations to said dowel pin tray for protecting said label panel when pouring a dental mold, said line of perforations allowing said protective plate to be easily removed after the mold is poured.

21. The device as set forth in claim 10, wherein said side surface further includes protruding teeth patterns onto which information relating to tooth shades may be written.

22. The device as set forth in claim 10, wherein said side surface includes a pre-printed paper adhesive label applied thereon.
